(19) United States
(12) Patent Application Publication
(10) Pub. No.: US 2009/0007158 A1
(43) Pub. Date: Jan. 1, 2009

(54) Emulating a display mode for a clone display

(76) Inventors: Mohamad Hasmizal Azmi, Penang (MY); James Vogt, El Dorado Hills, CA (US)

Correspondence Address: TROP PRUNER & HU, PC, 1616 S. VOSS ROAD, SUITE 750, HOUSTON, TX, 77057-2631, US

(21) Appl. No.: 11/824,189

(22) Filed: Jun. 29, 2007

(51) Int. Cl. G06F 3/00

(52) U.S. Cl. 719/328

(57) ABSTRACT

In one embodiment, the present invention includes a method for receiving a request to provide display information in a video graphics adapter (VGA) mode, determining if a flag corresponding to an enabled state of a clone display is active, and forwarding the request to a video electronics standards association (VESA) function based on the flag, and setting configuration information to VESA values prior to executing the VESA function. Other embodiments are described and claimed.

### BACKGROUND

In many computer systems, multiple displays can be coupled to a single system. For example, a personal computer (PC) may include multiple flat panel displays to enable viewing of greater amounts of information, clone mode information and so forth. While a graphics controller such as a graphics memory controller (GMC) may have multiple display planes including video planes and graphics planes, among others, that can provide display information to both a primary display and a clone display during normal execution, oftentimes this is not the case for pre-boot modes or legacy video modes such as a video graphics adapter (VGA) mode. That is, some graphics controllers have a hardware limitation that make it unable to provide VGA display information in a clone mode. Accordingly, certain display information such as status information during a pre-boot environment cannot be displayed in the system.

### BRIEF DESCRIPTION OF THE DRAWINGS

FIG. 1 is a block diagram of a system in accordance with an embodiment of the present invention.

FIG. 2 is a flow diagram of a method in accordance with one embodiment of the present invention.

FIG. 3 is a block diagram of a system in accordance with one embodiment of the present invention.

### DETAILED DESCRIPTION

In various embodiments, a clone display coupled to a system having a primary display may operate during pre-boot and boot environments, even where a hardware limitation prevents display of video graphics adapter (VGA) data in clone mode. That is, in various embodiments, a request for VGA mode operation may be converted to a request for a different mode of operation such as a video electronics standards association (VESA) mode or another extended graphics mode such as a video basic input/output system (BIOS) extension (VBE) mode. In this way, display of status or other data in a clone mode may be realized during pre-boot and boot environments.

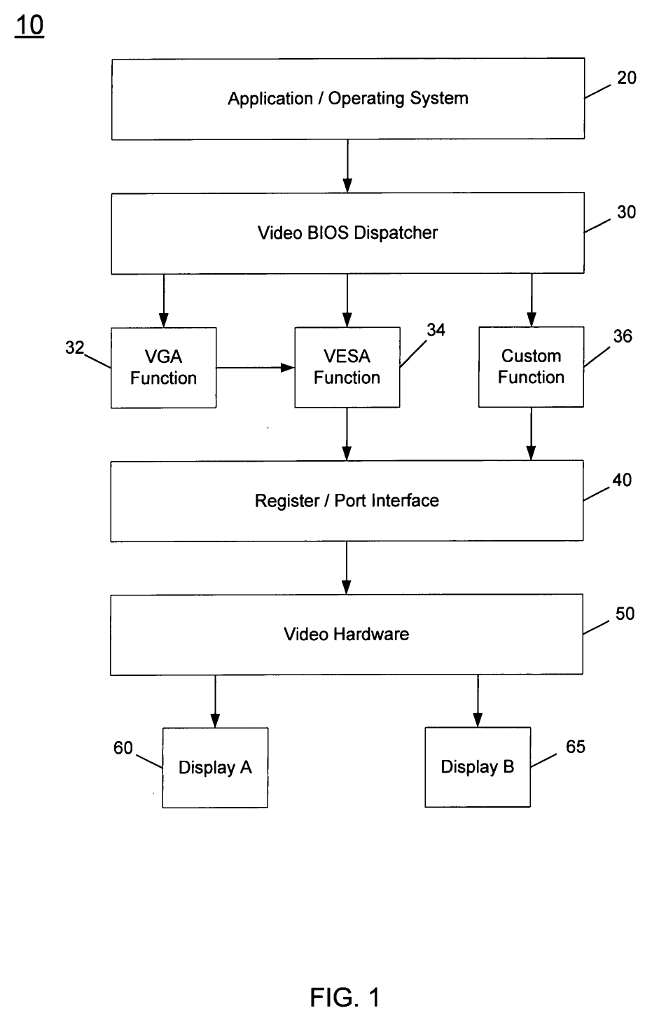

Referring now to FIG. 1, shown is a block diagram of a system in accordance with an embodiment of the present invention. As shown in FIG. 1, system 10 includes both software, firmware and hardware to enable embodiments of the present invention. Specifically, an application/operating system (OS) 20 may be present that provides a request, e.g., for a VGA mode of display during pre-boot activity such as power-on self test (POST) or other basic input/output system (BIOS) operations. The request may be provided from application/OS 20 to a video BIOS dispatcher 30, which may be part of a video BIOS of a system. As shown, video BIOS dispatcher 30 is coupled to various functions of the video BIOS system such as a VGA function 32, a VESA function 34, as well as a custom function 36, which may provide for functionality in addition to VGA and VESA functions. To enable embodiments of the present invention, when a VGA request is received and provided to VGA function 32, it is converted to a VESA function 34 to provide emulated VGA mode operations in VESA mode.

Accordingly, the execution of code in VESA function 34 and/or custom function 36 may lead to the output of data to a register/port interface 40 which in turn may be coupled to video hardware 50, which may be a graphics card that converts the data in accordance with a given graphics capability. Note further that multiple displays may be coupled to video hardware 50 by different pipes, including a first display 60, which may be a primary system display, and a second display 65, which may be a clone display. While shown with this particular implementation in the embodiment of FIG. 1, understand the scope of the present invention is not limited in this regard.

Thus using embodiments such as shown in FIG. 1, all requests for VGA modes of operation may be converted to VESA mode requests. In various embodiments, code within video BIOS dispatcher 30 and/or VGA function 32 may be included to force all such VGA mode requests to VESA mode requests as a default. Accordingly, when system BIOS or an application intends to set a video mode to VGA mode, it may send a VGA interrupt 10h function zero (i.e., a set mode function) to pass a mode value to video BIOS dispatcher 30. To effect operation in accordance with an embodiment of the present invention, video BIOS dispatcher 30 may intercept this VGA call and reroute it to a VESA call, e.g., by replacing a VGA mode number with a VESA mode number. Accordingly, the request may be handled as a VESA mode request provided to VESA function 34. Note that VESA function 34 may perform code to use a VESA plane which uses a display plane A and pipe A, rather than a VGA plane. In this way, the possibility of supporting clone mode may be realized. Assuming that a second pipe (i.e., to clone mode display 65) has been set for clone mode operation, this request thus automatically activates the second pipe to enable clone mode operation and display of data to the clone mode.

In various embodiments, in order to maintain backwards compatibility without affecting existing implementations, a mechanism may be provided to enable/disable embodiments. In one embodiment, a field configuration may be provided that holds a user configurable value to determine whether video BIOS should operate with clone mode enabled or disabled. In one embodiment, the field may be an integer value that is used to differentiate between enabling and disabling VESA mode conversion. Accordingly, the flag may be used to set both display pipes to VESA mode operation in the enabled state. In one embodiment, when in the enabled state, both pipes may follow the default mode specified in a configuration file. In order for both displays to be enabled, both pipes may be set to VESA mode, although the second pipe may already be active.

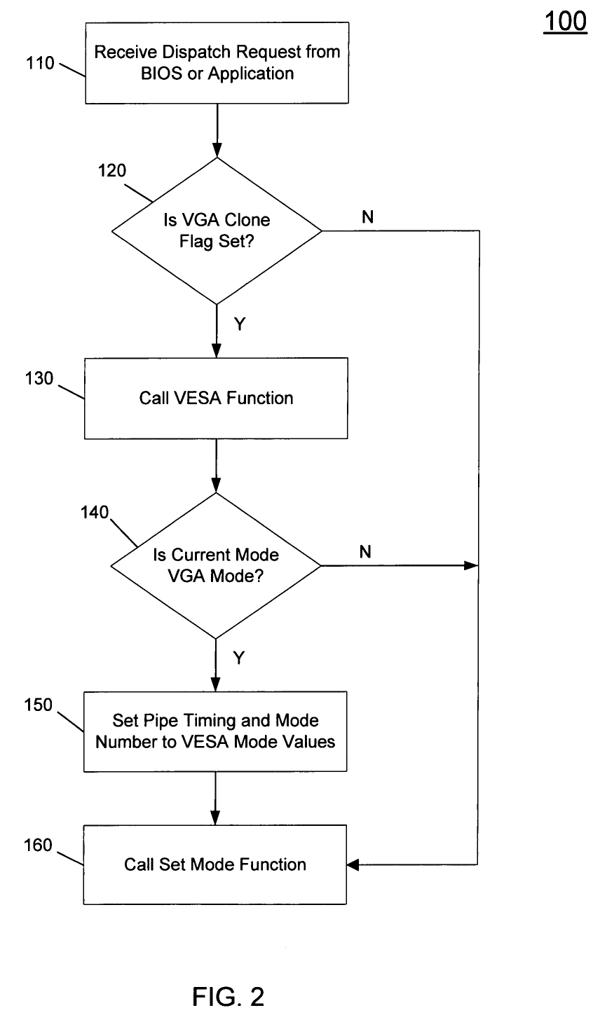

Referring now to FIG. 2, shown is a flow diagram of a method in accordance with one embodiment of the present invention. As shown in FIG. 2, method 100 may begin by receiving a dispatch request from BIOS or an application (block 110). Next, it may be determined whether a VGA clone flag is set (diamond 120). That is, it may be determined whether clone mode is enabled. If not, control passes to block 160, where a set mode function may be called. Accordingly, a given mode of the request, e.g., a VGA or VESA mode function may be called.

Referring still to FIG. 2, if instead at diamond 120 it is determined that the VGA clone flag is set, control may pass to block 130. At block 130 a VESA function may be called. There, it may be determined whether the current mode is VGA mode. That is, it may be determined whether the configuration file holding a default value is in VGA mode (diamond 140). If not, control passes to block 160, discussed above. If instead it is determined at diamond 140 that the current mode is in VGA mode, configuration information must be changed. Accordingly, control passes to block 150, where the configuration information, for example, pipe timing and mode number may be reconfigured to VESA values (block 150). As described above, this configuration information may be updated within a configuration file for the default mode. Then control passes to block 160. While shown with this particular implementation in the embodiment of FIG. 2, the scope of the present invention is not limited in this regard.

In various embodiments, certain video BIOS routines may be modified to implement embodiments of the present invention. For example, a dispatch function may be updated to enable VGA mode requests to be handled in VESA mode when clone display mode is active. Other implementations may update various functions such as a VBE function which may receive system BIOS calls. For example, a handler may be provided to check for VGA mode requests that are incoming. If clone mode is enabled, the handler may perform a conversion to translate the VGA mode request to a VESA mode request. Still further, color palettes may be updated to enable display of desired color information in VESA mode during clone operation.

Accordingly, various embodiments may be used to boot in clone mode to enable status displays on both a primary display and a clone mode display, as both display pipes may be transferred or forced into a VESA mode to enable VGA emulation in the VESA mode.

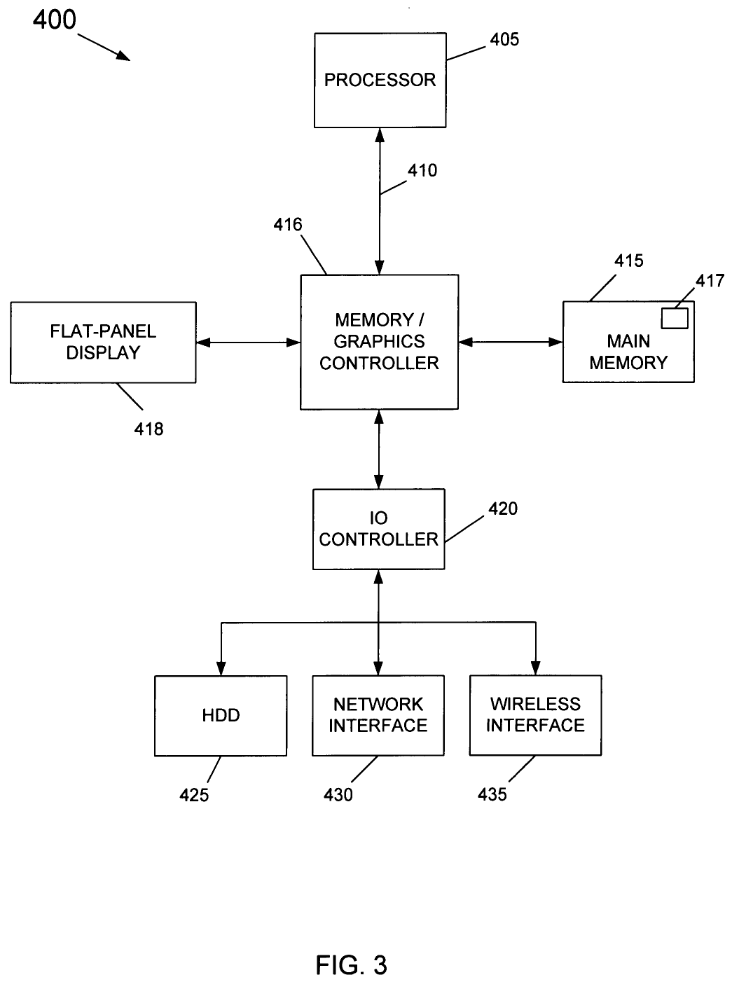

Referring now to FIG. 3, shown is a block diagram of a system in accordance with one embodiment of the present invention. As shown in FIG. 3, system 400 includes a processor 405 coupled to a graphics memory controller (GMC) 416 via a bus such as a front side bus (FSB) 410. GMC 416 in turn is coupled to a memory 415 that may be, for example, a dynamic random access memory (DRAM). As shown, during operation of embodiments of the present invention, code 417, which may include instructions corresponding to the flow diagram of FIG. 2, may be executed by processor 405. Furthermore, GMC 416 is coupled to a display 418 (such as a flat panel display). GMC 416 may include an integrated graphics accelerator. GMC 416 is further coupled to an input/output (I/O) controller 420, which may be used to couple various peripheral devices to system 400. Shown for example in the embodiment of FIG. 3 is a hard disk drive (HDD) 425, a network interface 430, and a wireless interface 435, each of which is coupled to I/O controller 420. While shown with this particular implementation in the embodiment of FIG. 3, the scope of the present invention is not limited in this regard.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a request to provide display information in a video graphics adapter (VGA) mode;
determining if a first flag corresponding to an enabled state of a clone mode for a second display coupled to a system is active; and
forwarding the request to a video electronics standards association (VESA) function if the first flag is active, setting a pipe timing and mode number to a VESA value if a current value for the pipe timing and mode number corresponds to a VGA value, and executing the VESA function.

2. The method of claim 1, further comprising receiving the request from an application or an operating system.

3. The method of claim 1, further comprising calling a set mode VESA function to enable the second display in a VESA mode.

4. The method of claim 3, further comprising receiving the request from a system basic input/output system (BIOS), wherein the request is for the VGA mode for display of status information in a pre-boot environment of the system.

5. The method of claim 4, further comprising displaying the status information on the second display in the VESA mode.

6. The method of claim 5, further comprising translating the request from the VGA mode request to a VESA mode request to thereby emulate the VGA mode in the VESA mode.

7. The method of claim 1, further comprising receiving the request in a video BIOS extension (VBE) function and converting the request from a VGA request to a VESA request in the VBE function.

8. An apparatus comprising:
a processor to receive a request for display of status information according to a first mode, determine if a clone mode operation of a clone display coupled to a system by a second pipe is enabled, if so convert the request from the first mode to a second mode, and forward the second mode request to a video module to perform the request in the second mode, wherein the processor is to update configuration information of a primary display coupled to the system by a first pipe from the first mode to the second mode before execution of the video module.

9. The apparatus of claim 8, wherein the first mode corresponds to a video graphics adapter (VGA) mode and the second mode corresponds to a video electronics standards association (VESA) mode.

10. The apparatus of claim 9, wherein the configuration information corresponds to a pipe timing and mode number.

11. The apparatus of claim 9, wherein the processor is to receive the request from a system basic input/output system (BIOS), and a video BIOS is to convert the request from the first mode to the second mode.

12. The apparatus of claim 11, further comprising a graphics card to output status information to the clone display in a pre-boot execution environment responsive to the request.

13. The apparatus of claim 8, wherein the processor is to check a value of a flag to determine if the clone mode operation is enabled.
